(19) United States
(12) Patent Application Publication
(10) Pub. No.: US 2011/0036973 A1
(43) Pub. Date: Feb. 17, 2011

(54) ION PUMP

(75) Inventors: David Ruiz Alonso, Cambridge (GB); Andrew Koehl, Cambridge (GB); Paul Boyle, Cambridge (GB); Martyn Rush, Cambridge (GB); Russell Parris, Cambridge (GB); Ashley Wilks, Cambridge (GB)

Correspondence Address: LANDO & ANASTASI, LLP, ONE MAIN STREET, SUITE 1100, CAMBRIDGE, MA, 02142, US

(73) Assignee: OWLSTONE LTD, Cambridge (GB)

(21) Appl. No.: 12/067,428

(22) PCT Filed: Sep. 19, 2006
(86) PCT No.: PCT/GB2006/050294

§ 371 Date: Aug. 27, 2010

(30) Foreign Application Priority Data
Sep. 19, 2005 (US) 11/231196
Oct. 21, 2005 (GB) 0521451.5

(51) Int. Cl. H01J 49/42

(52) U.S. Cl. 250/282; 250/288

(57) ABSTRACT

The invention provides an ion pump to be used for selectively transferring ionised molecules across a barrier from a first volume to a second volume. The pump comprises an ion gate or filter separating the two volumes, the filter comprising at least one ion channel extending between the first and second spaces, the channel defined by a plurality of conductive layers separated along the length of the channel by at least one non-conductive layer; the device further comprising control means for applying an electric potential to the conductive layers such that the conductive layers act as electrodes. Other aspects of the invention relate to methods for selectively transferring ions.

### FIELD OF THE INVENTION

The present invention relates to an ion pump, and in particular to a device for selectively transferring ionised molecules across a barrier. Particular embodiments of the invention relate to a system for selectively increasing the concentration of a desired species in a volume. Other embodiments relate to devices and methods for separation of ions from a neutral carrier fluid. More specifically, these embodiments relate to transfer of ions in a first carrier gas to a second carrier gas.

### BACKGROUND OF THE INVENTION

Ion mobility spectrometry is a versatile technique used to detect presence of molecular species in a gas sample. The technique has particular application in detection of explosives, drugs, and chemical agents in a sample, although it is not limited to these applications. Portable detectors are commonly used for security screening, and in the defence industry.

Ion mobility spectrometry relies on the differential movement of different ion species through an electric field to a detector; by appropriate selection of the parameters of the electric field, ions having differing properties will reach the detector at differing times, if at all. Time of flight (TOF) ion mobility spectrometry measures the time taken by ions when subject to an electric field to travel long a drift tube to a detector against a drift gas flow. By varying the electric field ions of different characteristics will reach the detector at different times, and the composition of a sample can be analysed.

Field asymmetric ion mobility spectrometry (FAIMS) is a derivative of time of flight ion mobility spectrometry (TOFIMS). Background information relating to FAIMs can be found in LA. Buryakov et al. Int. J. Mass. Spectrom. Ion Process. 128 (1993) 143; and E. V. Krylov et al. Int. J. Mass. Spectrom. Ion Process. 225 (2003) 39-51; hereby incorporated by reference.

Conventional FAIMS operates by drawing air at atmospheric pressure into a reaction region where the constituents of the sample are ionized. Chemical agents in vapour-phase compounds form ion clusters when they are exposed to their parent ions. The mobility of the ion clusters is mainly a function of shape and weight. The ions are blown between two metal electrodes, one with a low-voltage DC bias and the other with a periodic high-voltage pulse waveform, to a detector plate where they collide and a current is registered. Ions are quickly driven toward one electrode during the pulse phase and slowly driven toward the opposite electrode between pulses. Some ions impact an electrode before reaching the detector plate; other ions with the appropriate differential mobility reach the end, making this device a sort of differential mobility ion filter. A plot of the current generated versus DC bias provides a characteristic differential ion mobility spectrum. The intensity of the peaks in the spectrum, which corresponds to the amount of charge, indicates the relative concentration of the agent.

The present inventors have developed a modification of FAIMS, which does not require a drift gas flow for its operation. Instead, an electric field is used to cause ions to move toward the detector. This allows for a solid state construction which does not require a gas pump or similar, so allowing for greater miniaturisation of the device than would otherwise be possible, as well as a more robust construction. An ion filter is used which permits selected ion species to pass through the filter to the detector. The ion filter is tunable by varying the electric field applied thereto to allow different species to pass.

A spectrometer incorporating the ion filter is described in international patent application PCT/GB2005/050124, the contents of which are incorporated herein by reference. Briefly, the filter operates as follows. The filter structure comprises a plurality of ion channels formed by a pair of interdigitated structures. A plurality of electrodes are disposed proximate each ion channel, and in use the electrodes are controlled such that a first drive electric field is generated along the length of the ion channels, and a second transverse electric field is generated orthogonal to the first. The transverse field acts as a filter, driving ions of other than the selected mobility into the walls of the ion channel, while ions having the selected mobility are able to pass through the channels. In preferred embodiments the transverse field has an AC component and a DC component.

An alternative ion filter construction is described in international patent application PCT/GB2005/050126, the contents of which are incorporated herein by reference. The filter structure comprises a similar interdigitated structure defining a plurality of ion channels. The filter is formed of a plurality of conductive layers separated along the length of the channels by at least one non-conductive layer. By application of electric potential to the conductive layers, an electric field may be established within the ion channel. This electric field will affect the mobility of ions within the channel according to the nature of the field and the charge of the ions, and so can be used to selectively admit ions through the channel to the detector.

The present inventors have now determined that the ion filter structures described in these earlier patent applications for use in ion mobility spectrometers may be used in other devices, and in particular as an ion pump.

### SUMMARY OF THE INVENTION

According to a first aspect of the present invention, there is provided a device for selectively transferring ionised species from a first space to a second space, the device comprising first and second spaces separated by an ion filter allowing selective communication between the spaces; the ion filter comprising at least one ion channel extending between the first and second spaces, the channel defined by a plurality of conductive layers separated along the length of the channel by at least one non-conductive layer; the device further comprising control means for applying an electric potential to the conductive layers such that the conductive layers act as electrodes.

It will be understood that “conductive” and “non-conductive” are relative terms, such that the conductive layers exhibit lower electrical resistance than the non-conductive layer; however, the nor-conductive layer may nonetheless conduct electricity to some degree. For example, the non-conductive layer may comprise a semiconductor. It will be seen that the conductive layers will act as electrodes or as electrical contacts allowing the electric potential across the ion filter to be controlled.

By application of electric potential to the conductive layers, an electric field may be established within the ion channel. This electric field will affect the mobility of ions within the channel according to the nature of the field and the charge of the ions, and so can be used to selectively admit ions through the channel between the spaces.

By “separated along the length of the channel”, we mean that the intended direction of movement of ions through the channel defines a length, and the conductive layers are interrupted along this length by the non-conductive layer, such that the conductive layers do not extend continuously along this length.

The first and second spaces may be separated by a barrier, and the ion filter disposed within the barrier. Preferably the barrier is substantially impermeable at least to the ion species of interest, and more preferably substantially impermeable to other ionic and non ionic species. However, provided the rate of pumping provided by the ion filter is greater than the natural diffusion rate across the barrier, a permeable barrier will also work effectively.

Preferably the control means allow electric potential to be applied to the conductive layers such that a first drive field is generated along the length of the ion channel, and a second transverse field is generated orthogonal to the first. Preferably also each of said plurality of conductive layers is involved in generating a component of both the drive and transverse electric fields.

This arrangement allows for the drive electric field to be used to propel ions through the channel, while the transverse electric field may be used to selectively affect the mobility of ions according to parameters such as their charge. The drive and transverse electric fields are preferably applied simultaneously. Use of the same electrodes to generate components of both drive and transverse electric fields minimises the number of electrodes needed, as well as reducing the size of the device. In certain embodiments of the invention, additional electrodes may however be present, and not all of the electrodes in the filter need be involved in generating a component of both the drive and the transverse electric fields. The drive field is preferably a longitudinal electric field.

Preferably the control means allows the application of a time-varying electric potential to the conductive layers. The electric potential may be oscillating, and is conveniently in the form of a square wave. The electric potential may be time-varying in an asymmetric manner.

The control means preferably allows the electric potential to be selectively varied; this allows for the field to be tuned in order to permit passage of particular ions.

Preferably the drive electric field is a static electric field; that is, the field does not vary over time. However, a time-varying drive field can be employed, for example, to adjust the width of the resolution peaks and thus configure an instrument for optimum performance in a particular application. In some instruments the field may be swept over a range of field strengths. In this way drive field strength may be used as a further parameter for filtering. The field may be generated by application of a DC bias across the conductive layers. It has been found that a continuous, static electric field is sufficient to drive ions along the ion channel while the transverse field separates the ions according to mobility, and hence parameters such as shape, mass and charge; this combination of fields removes the need for a drift gas flow.

The transverse electric field may vary over time, and may be generated by application of an AC voltage across the conductive layers. The AC voltage is preferably asymmetric. Thus in preferred embodiments of the invention, the transverse electric field comprises an AC component and a DC component. The DC component is preferably opposed to the AC component; that is, the AC component will tend to drive ions towards one side wall of the ion channel, while the DC component will tend to drive the ions towards the other side wall of the channel. A DC ramp or sweep voltage may also be added and parameters of the AC voltage such as amplitude, duty cycle and the like may also varied to obtain sweep and improve sensitivity and selectivity or other effects.

Preferably the conductive layers are disposed adjacent the entrance and exit to the ion channel. Alternatively the conductive layers may be disposed within the channel itself.

The conductive layers may form at least two electrode or electrical contact pairs; one electrode is conveniently situated at each corner of the channel. That is, four electrodes form four electrode pairs: two transverse pairs which serve to generate a transverse field, and two longitudinal pairs which generate a drive field. Each electrode is a member of two pairs, one transverse pair and one drive pair. The electrode pairs are transversely separated by the channel itself, while the pairs may be vertically separated by a resistive (eg 1-100 KΩcm resistive silicon) semiconducting or insulating material to provide structural stability. Preferably four electrodes are provided at each ion channel.

The filter preferably comprises a plurality of ion channels, and conveniently more than 5, more than 10, more than 15, and more than 20 ion channels. The channels may conveniently be defined by a plurality of electrode fingers forming a comb-like arrangement. In preferred embodiments, the filter comprises two or more interdigitated electrode arrays, each array having a plurality of electrode fingers. The presence of multiple ion channels provides a relatively large area through which ionised species may move, but the narrow size of the individual channels avoids passage of non ionised molecules across the filter.

Preferably the ion channels are elongate; that is, they have a relatively short length (the direction along which ions will flow) and a relatively short width (in a minor transverse direction), with a relatively long depth (in a major transverse direction).

Optionally the interdigitated fingers may be curved, more particularly serpentine, and in this way may then define curved or serpentine channels. This has the advantage of reducing diffusion losses which, with straight electrodes, are caused by ions diffusing into the walls of the channels. With curved or serpentine electrodes these diffusion losses are reduced (and the channel width in this sense is effectively increased) because of the formation of a partial potential well within a channel. Curved or serpentine channels also reduce the deleterious effects of space charge repulsion.

The filter may comprise a resistive or semiconductive substrate on which the conductive layers and non-conductive layer are provided. The substrate and/or the non-conductive layer may comprise silicon, conveniently in the form of silicon dioxide or silicon nitride. The substrate may be in the form of a silicon wafer. The conductive layers may comprise doped polysilicon. In preferred embodiments, the conductive and non-conductive layers (and optionally the substrate, if a separate substrate is provided) may conveniently be etched to form a desired shape and configuration, and to provide the ion channels, using conventional semiconductor processing techniques. This allows many channels to be formed in parallel, and on a small scale.

Preferably the length of the ion channel is less than the depth of the filter, and preferably significantly less; for example, at least 10 times less. In preferred embodiments, the filter has a generally wafer-like form, with the channel length being a fraction of the filter depth. In a particularly preferred embodiment, the channel length is less than 1000 microns, less than 900 microns, and less than 800 microns, while the filter width is more than 10,000 microns. Preferred channel lengths are from 1000 to 100 microns, more preferably 800 to 300 microns, and most preferably 500 to 300 microns.

Preferably also the width of the ion channel (that is, the gap spacing across the channel over which the transverse electric field is generated) is less than the channel length. In preferred embodiments the gap spacing is between 10 and 100 microns. Such an arrangement allows the generation of relatively large electric fields across the channel length with relatively low voltages and power consumption. In preferred embodiments of the invention, the electric fields may be large enough to cause ion fragmentation or ion cracking. This allows large ion species to be fragmented into smaller species, which may be of use in some applications.

Conveniently at least two, and preferably two, conductive layers are provided. A plurality of non-conductive layers are conveniently provided, and preferably two. The conductive layers may alternate with non-conductive layers (that is, a non-conductive layer is interposed between each pair of conductive layers); in a preferred embodiment, the filter has the structure C-NC-C-NC- (and optionally, a substrate), where C and NC represent conductive and non-conductive layers respectively.

In an alternative preferred embodiment, the filter has the structure C-NC-substrate-NC-C; that is, the substrate carries a non-conductive layer on both faces with a conductive layer above the non-conductive layer. This embodiment is particularly suited for use where a distinct substrate is provided.

The device preferably comprises means for heating the filter. Preferably the filter may be heated to at least 150° C. Heating the filter can improve performance, and will assist in removing contaminants from the filter. A separate heater may be provided (for example, a substrate on which the filter is mounted), although preferably the heating means is integrated with the filter. In preferred embodiments, the filter comprises a substrate which is heated, for example by Joule effect heating when a voltage is applied across the substrate. If the substrate is integrated into the filter, then such a voltage will be applied when the filter electrodes are actuated. The preferred microscale embodiments of the invention allow relatively low voltages to be used to provide effective heating by the Joule effect.

In embodiments the channels are substantially perpendicular to a face of the filter. Preferably the filter has face area to channel length ratio of greater than 1:1, more preferably greater than 10:1 or 100:1. For example a filter may have an 8 mm×8 nm face area and a channel length of approximately 200 mm.

The device may further comprise one or more of the following additional components; in preferred embodiments, each of these forms an additional functional layer mounted on the filter:

a) An inlet layer may be present, to prevent unwanted particles from entering the filter while permitting desired ion species to diffuse into the device. The inlet layer is conveniently made from a porous material, such as a porous ceramic.
b) A dehumidifier layer to deplete water vapour from the device. This layer may comprise an absorbent material; alternatively a desiccant or similar may be used. The layer may further include a heating element, which may be used to purge the absorbent material periodically.
c) A preconcentrator layer, to accumulate and periodically release ion species to effectively concentrate the species. This is particularly useful when the device is to be used in a spectrometer or other analysis device. This layer may also comprise an absorbent material, such as a molecular sieve having pores of an appropriately large size to absorb the desired range of analytes. A heating element may then be activated to release absorbed analytes periodically.
d) A dopant layer comprising a material impregnated with a desired chemical or dopant that is released or desorbed from the layer and into the active region to affect chemical reactions and therefore modify performance. This could be for example ammonia to enhance atmospheric pressure ionization of certain compounds or could be for example water, which is known to enhance separation of compounds in the spectrum and therefore resolution.
e) The device may further comprise a deflector, for deflecting ions towards the ion detector. This may be achieved by use of a deflector electrode and by establishing an electric field gradient between the deflector electrode and the filter. Such an arrangement permits ions to be driven through the filter and towards the detector without the use of a drift gas flow (although the device may be used in combination with a drift gas flow in some circumstances).

The device may also comprise means for generating a gas counterflow through the filter against the direction of movement of ions. Rarely will all of a sample be ionised, such that intact molecules or partial ionisation products may enter the filter. Such molecules in the filter region may lead to further reactions and interactions, which cause deleterious effects such as peak shifting etc. The use of a gas counterflow can assist in removing contaminants from the filter, or in maintaining an unreactive environment within the filter. The gas used may be unreactive—for example, nitrogen or helium—or may be selected to affect affinity of contaminants to ionisation—for example, ammonia, DCM etc may be used. A gas counterflow can also be used to alter mobility of ions within the filter. The gas counterflow may be at a very low flow rate; for example, a minimal pressure difference between sides of the filter is generally sufficient, since the flow is not needed to move ions (unlike gas flows in conventional ion spectrometers). Thus miniaturised pumps or diaphragms may be used, with relatively low power consumption; or a pressurised gas reservoir may be used.

In certain embodiments of the invention, either or both of the first and second spaces may carry a gas flow therethrough. For example, the first and second spaces may be inlet tubes leading towards a detector, and the ion filter may be used to transfer ions from the first tube to the second tube. The first and second gas flows may travel in the same direction, or in opposite directions. Uses of the present invention include transferring ions from atmospheric gas (that is, a ‘dirty’ gas flow) to a clean or inert gas flow of known composition. Alternatively, the device may be used to transfer ions from a high pressure or high concentration volume or gas flow to one of low pressure or low concentration.

A further aspect of the invention provides a device for selectively transferring ionised species from a first space to a second space, the device comprising first and second spaces separated by a non-permeable barrier; and an ion filter disposed within the barrier and allowing selective communication between the spaces; the ion filter comprising at least one ion channel along which ions may pass from the first to the second space; wherein the ion filter comprises a plurality of electrodes disposed proximate the ion channel; the device further comprising electrode control means for controlling the electrodes such that a first drive electric field is generated along the length of the ion channel, and a second transverse electric field is generated orthogonal to the first, and wherein each of said plurality of electrodes is involved in generating a component of both the drive and transverse electric fields.

In certain embodiments of the invention, an ion gate is disposed between a first volume occupied by a first carrier gas and ions of the first carrier gas and a second volume occupied by a second carrier gas. The ion gate includes at least one channel connecting the first volume to the second volume, a first electrode disposed on an inlet surface of the ion gate facing the first volume, and a second electrode disposed on an outlet surface of the ion gate facing the second volume. Ions are transported from the first volume to the second volume through the channel under an electric field produced by the first and second electrodes.

One embodiment of the present invention is directed to a device comprising: a first carrier gas occupying a first volume, the first carrier gas including ions; a second carrier gas occupying a second volume; an ion gate disposed between the first and second volumes, the ion gate including at least one channel allowing ions in the first volume to enter the second volume, a first electrode at a first electric potential disposed on an inlet surface of the ion gate, a second electrode at a second electric potential disposed on an outlet surface of the ion gate, the first and second electric potential providing an electric driving force to transport ions in the first volume to the second volume through the at least one channel. In an aspect of the present invention, the at least one channel is characterized by a channel length that is less than 1 mm. Preferably, the channel length is less than 500 microns, and most preferably the channel length is less than 300 microns. In an aspect of the present invention, the at least one channel is characterized by a channel cross-sectional area that is between 10,000 μm² and 1 μm². Preferably, between 2,500 μm² and 10 μm², and most preferably between 1,000 μm² and 10 μm².

The invention also relates to such a device in which that first and second electrodes are capable of being held at the first and second electric potentials. That is, a device comprising: a first carrier gas occupying a first volume, the first carrier gas including ions; a second carrier gas occupying a second volume; an ion gate disposed between the first and second volumes, the ion gate including at least one channel allowing ions in the first volume to enter the second volume, a first electrode capable of being held at a first electric potential disposed on an inlet surface of the ion gate, a second electrode capable of being held at a second electric potential disposed on an outlet surface of the ion gate, in use the first and second electric potential providing an electric driving force to transport ions in the first volume to the second volume through the at least one channel.

A further aspect of the invention provides a method for selectively transferring ions from a first space to a second space, the method comprising the steps of:
locating ions adjacent an ion channel, the ion channel being defined by a plurality of conductive layers separated along the length of the channel by at least one non-conductive layer;
biasing the ions such that, in the absence of other forces, they would tend to travel along the ion channel; and
applying electric potential to the conductive layers, such that an electric field is established within the ion channel to selectively permit or prevent passage of the ions.

Preferably the ions are biased by application of a longitudinal drive electric field along the length of the channel.

The electric potential applied to the conductive layers is preferably a time-varying electric potential. The electric potential may be oscillating, and is conveniently in the form of a square wave. The electric potential may be time-varying in an asymmetric manner. The electric potential may comprise a transverse electric field, which may be in addition to or in place of the longitudinal electric field.

The method may further comprise the step of selectively varying the electric potential; this allows for the field to be tuned in order to permit passage of particular ions. Preferably the longitudinal electric field is a static electric field; that is, the field does not vary over time. However a time-varying field can also be employed, as previously mentioned. The field may be generated by application of a DC bias across the conductive layers.

The transverse electric field may vary over time, and may be generated by application of an AC voltage across the conductive layers. In preferred embodiments of the invention, the transverse electric field comprises an AC component and a DC component. The DC component is preferably opposed to the AC component; that is, the AC component will tend to drive ions towards one side wall of the ion channel, while the DC component will tend to drive the ions towards the other side wall of the channel. Parameters may be varied as previously described.

The drive and transverse electric fields are preferably provided simultaneously. Preferably the drive and transverse electric fields are generated by a plurality of electrodes, each electrode contributing a component of both the drive and the transverse electric fields.

### BRIEF DESCRIPTION OF THE DRAWINGS

These and other aspects of the present invention will now be described by way of example only and with reference to the accompanying drawings in which:

FIG. 1 shows a first embodiment of a filter as may be used with the present invention;

FIG. 2 shows a second embodiment of a filter as may be used with the present invention;

FIG. 3 shows a third embodiment of a filter as may be used with the present invention;

FIG. 4 shows an example structure of filters as may be used with embodiments of the present invention;

FIG. 5 shows a device for selectively transferring ions in accordance with arm embodiment of the present invention; and

FIG. 6 shows a side section view of an embodiment of the present invention.

### DETAILED DESCRIPTION OF THE DRAWINGS

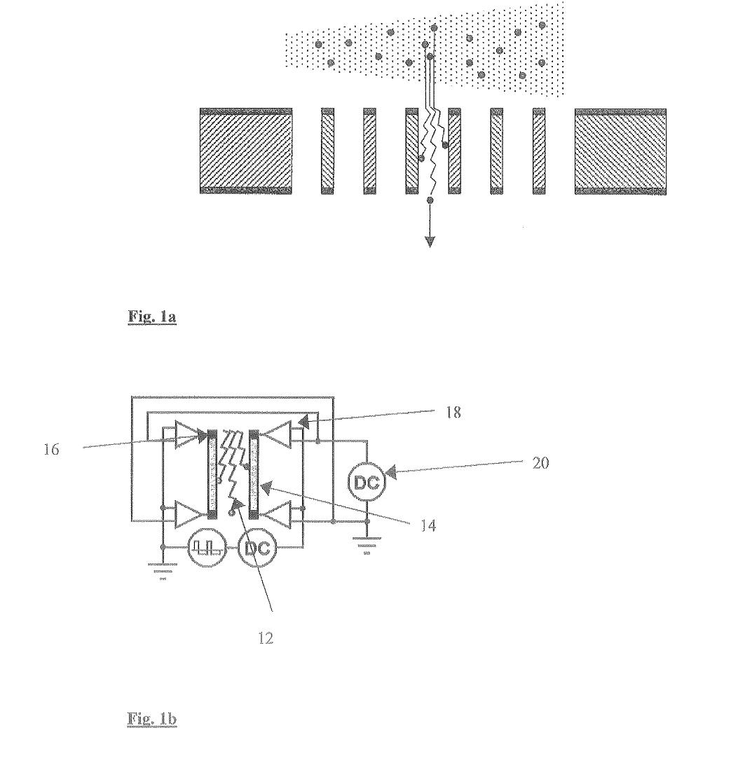

A schematic diagram of one embodiment of an ion filter which may be used in the present invention is shown in FIGS. 1a and 1b. Our approach centres on an innovative electrode geometry affording low voltage operation. An interdigitated electrode structure is formed by etching a dense array of narrow channels through high resistivity silicon. Ions are driven through the channels via a novel transport mechanism relying on electric fields instead of moving gas flows to achieve pumpless operation. Ion channels 12 are defined by the silicon substrate 14 which carries a conductive layer 16, defining electrodes at each corner of the entrance to and exit from the ion channel. The amplifiers 18 depicted represent analogue adders. In addition to the high-voltage pulse and low voltage DC bias generated across the channel, a further DC source 20 creates a drive electric field to drive ions through the channel, eliminating the need for a moving gas flow. A theoretical analysis has shown that ions can be propelled fast enough to avoid ion loss into channel walls due to diffusion. FIG. 1a shows a preferred embodiment having multiple ion channels, while FIG. 1b illustrates a single ion channel for clarity, together with the controlling electronics. The filter is typically operated with an electric field of 40 to 200 V across the channel, with the high-voltage pulse being typically from 3 MHz to 10 or 20 MHz. The drive field may generally be from 10 to 40 V.

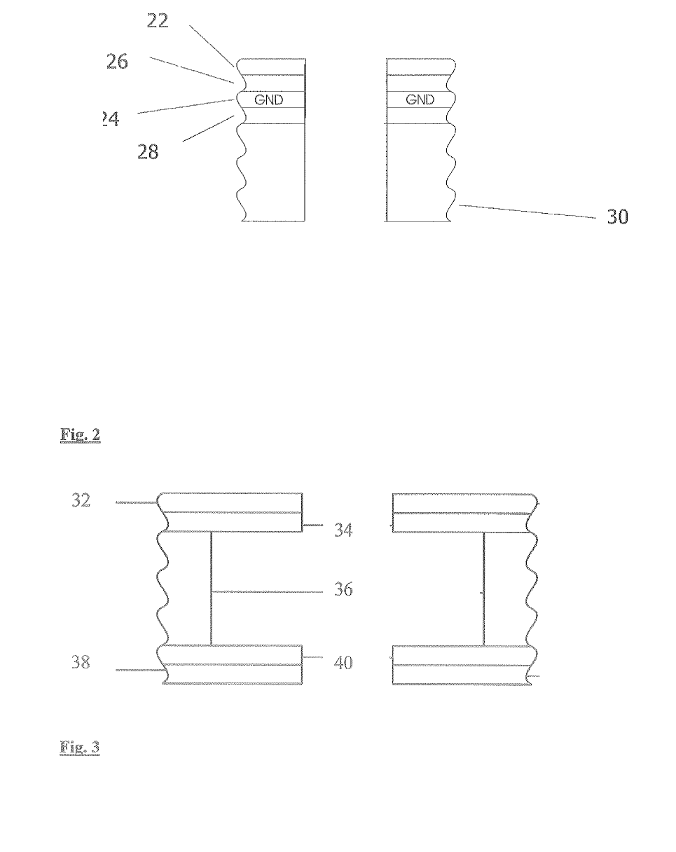

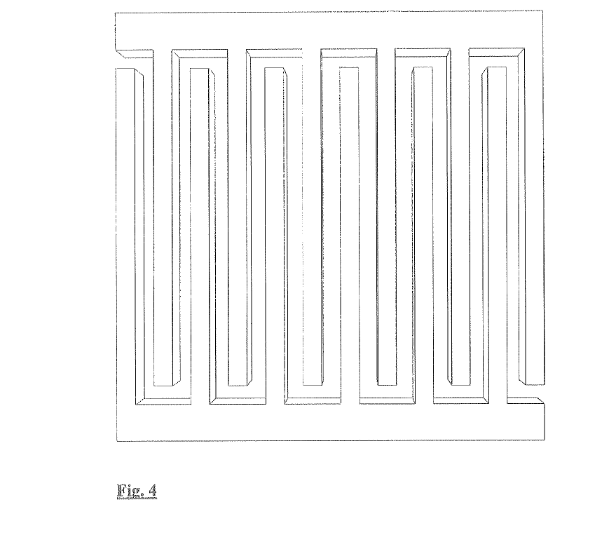

An alternative ion filter structure is shown in FIG. 2. In this embodiment, the structure consists of two conductive layers 22, 24 sandwiched between two insulative layers 26, 28 mounted on a glass substrate 30. The lower conductive layer acts as a guard electrode and is held at ground potential to prevent leakage currents. All layers may be on the order of several hundred nanometres thick. The conductive layers may be made of doped, polysilicon, the insulative layers may be made of silicon dioxide or silicon nitride. The layers are etched away to form the channel structure shown in FIG. 4. Conventional semiconductor processing techniques may be used to form many thousands of channels in parallel.

The filter structure can be manufactured by a range of conventional microfabrication techniques. One representative process involves the following steps. The substrate used is a high resistivity silicon wafer. Aluminium is deposited on the top and bottom faces of the wafer, followed by a photo resistant coating on each face. The top face is masked and subjected to photolithography, after which the aluminium coating of the top face is wet etched to provide an array of electrodes. The photoresist is stripped from both faces, and the process repeated to form the bottom face electrodes. A further resist coating is applied to the top face, after which the silicon is etched from the lower face using deep reactive ion etching to form channels. The photoresist is stripped for the final time, and the filter is ready for further processing.

In a variation of this technique, the silicon wafer may be initially bonded on the bottom face to a glass substrate; the various etching steps are then carried out from the top face to create channels and electrodes, after which the glass substrate is acid etched to expose the bottom face of the wafer, leaving a glass support in contact with the wafer. Other variations may include the use of substrates other than glass; and performing the steps listed in a different order.

The action of the filter structure is as follows. An oscillating waveform is applied to the top conductive layer 22 so that its potential is oscillated positive and negative with respect to the ground potential of the second conductive layer 24. Ions directed into the channel region, for example by a deflector electrode, by diffusion, or by a gas flow, are alternately driven through the ion channel towards the substrate 30 and then away from the substrate depending on the phase of the waveform. Ions with high enough velocities, and hence large mobility values, reach the substrate and hence pass through the channel. Ions with velocities that are too slow, and hence mobility values too small, do not pass through the channel.

An alternative filter structure is shown in FIG. 3. In this embodiment, the structure consists of a conductive layer 32 on top of an insulative layer 34 on one side of a silicon wafer 36, and a conductive layer 38 on top of an insulative layer 40 on the opposite side. All layers may be on the order of several hundred nanometres thick. The conductive layers may be made of doped polysilicon and the insulative layers may be made of silicon nitride. The layers and silicon wafer are etched away to form the supported membrane structure shown. Each conductive layer is patterned as shown in FIG. 4, which is an overhead view of the filter, showing the arrangement of two interdigitated electrodes. The insulative layers form a support membrane for structural rigidity. The silicon pillars between the membranes maintain a very precise fixed gap width and provide additional rigidity. In alternative embodiments, the electrodes may be curved or serpentine.

In use, a square waveform is applied across each of the interdigitated structures such that one phase of the waveform has zero value, making the structures behave as Bradbury-Nielson gates. When the potential applied across the interdigitated features is zero, the electric field in the vicinity of the gate region is perpendicular to the membrane so that ions are directed through it (the gate is “open”). When the potential applied across the interdigitated features is non-zero, the electric field in the vicinity of the gate region is approximately parallel to the membrane so that ions are directed into one of the gate electrodes and therefore cannot traverse the membrane (the gate is “closed”). The zero value used for each gate is slightly different, so that an electric gradient exists between the gates when open and ions tend to be directed through the filter structure during this phase. Only ions moving quickly enough (with high enough mobility values) can make it through the filter structure for a particular waveform frequency. Ions with high enough velocities, and hence large mobility values, pass through the filter. Ions with velocities that are too slow, and hence mobility values too small, do not pass through the filter.

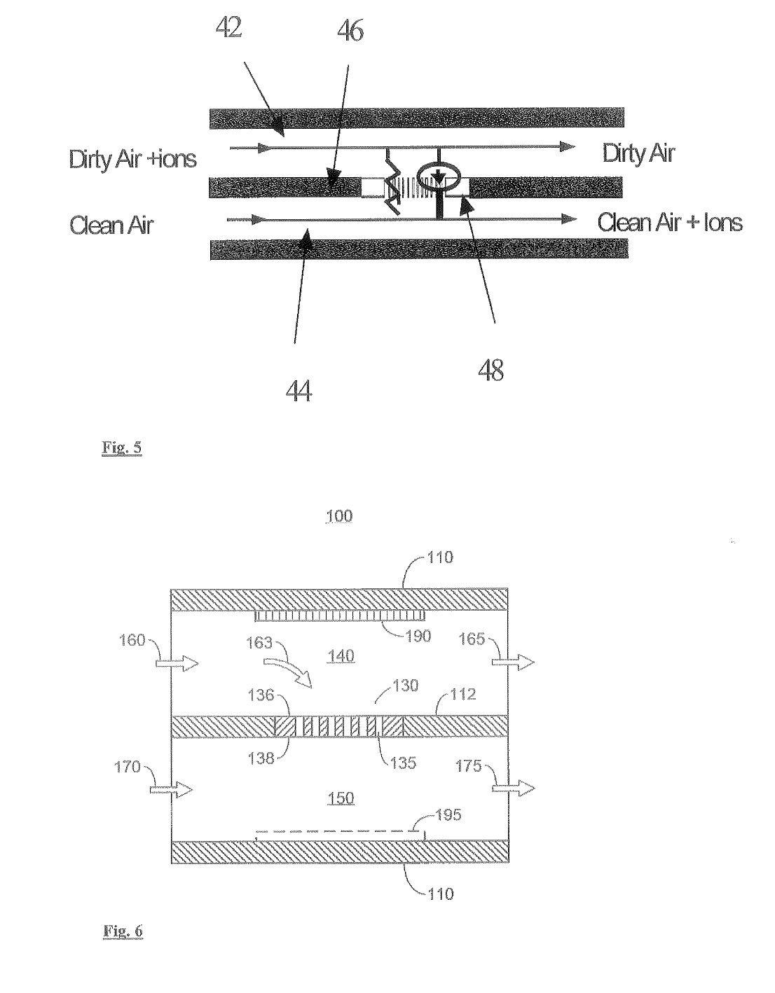

Incorporation of the filter structure into a device for selectively transferring ions from one region to another is shown in FIG. 5. First and second channels 42, 44 are separated by an impermeable barrier which has an ion filter 48 of the types described located therein, forming a selective passage between the first and second channels. In use, a first gas stream carrying a particular ion species is passed along the first channel. Operation of the ion filter allows ions from the first gas stream to pass through the filter and into the second channel, thereby selectively transferring ions from the first to the second channel. The device may rely on diffusion to propel ions into the filter, but in other embodiments the first and second channels may be at different gas pressures, such that there is a gas flow between the channels through the filter; or the first and second channels may be held at different electric potentials such that there is a longitudinal electric field gradient across the filter. The device may find use in many different situations. For example, the first channel may carry ‘dirty’ air taken from the atmosphere, while the second channel carries ‘clean’ air, such as a known composition of inert gases. Selected ion species may be passed into the clean air stream, and carried further for use in a spectrometer or other analytic instrument. Alternatively, the first and second channels may carry a counterflow of gas, and desired ion species may be scavenged from the first channel into the second; this may be useful where the overall concentration of the ion is low and recovery and reuse of ions in a process is desired.

Referring now to FIG. 6, this shows a cross-sectional view of an embodiment of the present invention. Walls 110 define a first volume 140 and a second volume 150 separated by divider 112. Divider 112 includes an ion gate 130 that allows ions to pass from the first volume 140 to the second volume 150 via channels 135. A first electrode 136 is disposed on an inlet surface of the ion gate and a second electrode 138 is disposed on an outlet surface of the ion gate. The ion gate is preferably composed of an insulating or high resistivity material such as, for example, silicon, Pyrex, silica, or quartz. A voltage potential is applied to the first and second electrodes such that ions in the first volume 140 are driven through the channels 135 into the second volume 150. An optional deflector electrode 190 is disposed in the vicinity of the ion gate 130 and an electric potential is applied to the deflector electrode 190 such that ions in the first volume 140 are deflected toward the inlet surface of the ion gate 130. A second optional deflector electrode 195 may be disposed in the second volume in the vicinity of the ion gate 130. The second optional deflector electrode may be biased to collect the ion transported through the ion gate or may be biased to control the potential in the second volume.

In a preferred embodiment, the first volume contains a first carrier fluid and ionized molecules of the first carrier fluid. The second volume contains a second carrier fluid that is preferably different from the first fluid. The fluid may be a liquid or a gas depending on the application of the ion gate. For example, the first and second carrier fluids may be gaseous when the ion gate is used in an ion mobility spectrometer. Alternatively, the first and second carrier fluids may be liquid when the ion gate is used in electrophoresis.

In FIG. 6, ions and a first carrier gas enter the first volume 140 as indicated by arrow 160. The first carrier gas includes neutral molecules and atoms that are sampled from the target environment. Generally, the number of chemical species and their identities in the first carrier gas are unknown. The ions mixed with the first carrier gas are ionized molecules or atoms of the first carrier gas. Ions mixed with the first carrier gas may be directed toward ion gate 130 as illustrated in FIG. 6 by arrow 163. Gas exiting the first volume 140, indicated by arrow 165 include the first carrier gas and preferably a depleted concentration of ions.

In FIG. 6, a second carrier gas enters the second volume 150 as indicated by arrow 170. The concentration and identity of the chemical species in the second carrier gas are preferably known and may be selected such that the chemical species in the second carrier gas do not interfere with downstream analysis of the ions or produce known detection signals that can be distinguished from the signals produced by the ions. Although FIG. 6 shows the first and second carrier gas flowing in the same direction, other configurations such as, for example, the first and second carrier gas flowing in opposite directions are within the scope of the present invention.

In a preferred embodiment, the ion gate is made of a high resistivity material such as, for example, silicon, quartz, silica, or Pyrex. Channels 135 may be manufactured using known MEMS processing methods such as, for example, Deep Reactive Ion Etching (DRIE) or laser drilling. The channel length, or the distance between the first and second volumes, is less than 1 mm, preferably less than 500 microns, and most preferably less than 300 microns. The cross-sectional area of each channel is between 1 μm² and 10,000 μm², preferably between 10 μm² and 2,500 μm², and most preferably between 10 μm² and 1,000 μm². The number of channels may be selected such that the total cross-sectional area of the channels is between 0.01 and 5 cm² and preferably between 0.1 and cm².

In some embodiments, the channels may have a rectangular cross-section such as, for example, a slot where the width of the channel is very much smaller than the height of the channel. Other configurations may include a serpentine slot. The width of the slot may be between 1 μm and 100 μm, preferably between 5 μm and 60 μm, and most preferably between 1 μm and 40 μm. The height of the slot may be between 10 and 10,000 times the slot width and preferably between 100 and 1,000 times the slot width.

In some embodiments, the second volume may be at a higher pressure relative to the pressure in the first volume. The pressure difference between the first and second volume creates a pressure head across the ion gate that induces a flow from the second volume to the first volume. It is believed that the high fluidic impedance of the ion gate reduces the transport of the second carrier gas into the first volume while still allowing ions in the first volume to be driven by the electrodes into the second volume. The reduction in transport is relative to a single convex channel with a cross section equal to the cumulative cross-sectional areas of the one or more channels in the ion gate.

In certain embodiments of the invention, the device may further comprise a membrane, and in particular a semi-permeable membrane. For example, the membrane may be made from expanded PTFE (such as that sold under the name GORE-TEX®), or from dimethylsilicone. Such semi-permeable membranes may find many uses in the invention.

An inlet to the device may be covered by a membrane. This has a number of functions; one is to prevent dust and particulates from entering the device, while the semi-permeable membrane still permits gaseous ions etc to enter. The membrane may exclude polar molecules from the active region of the filter; excessive polar molecules can lead to clustering which affects the operation of the device. Further, liquids may be passed over the membrane, such that substances can diffuse from the liquid into the device in gas phase, thereby permitting ion transfer from liquid samples. The membrane may incorporate a heating element; varying the temperature of the membrane can affect diffusion processes across the membrane so allowing additional selectivity.

Selection of appropriate membrane material may also be used to exclude particular molecular species from the device.

A membrane may also be used as a pre-concentrator; particularly if the membrane also incorporates a heating element. Substances may diffuse into the membrane where they will be held until the temperature is raised; this releases a relatively high concentration of substance into the device. The membrane may simply cover the inlet of the device, but in preferred embodiments may take the form of an inlet tube leading to the device.

In some embodiments of the invention, the filter structure may be fabricated as completely solid metal elements, for operating in gas flow mode, or as a metal coated silicon or other wafer structure. Metal coating may be formed by, for example, sputtering, evaporation, electroplating, electroless electroplating, atomic layer deposition, or chemical vapour deposition. A solid metal device may be produced by water cutting, laser cutting, machining, milling, or LIGA. Although this arrangement does not have the advantages of a purely electric field driven device, the ability to make use of a miniaturised filter with a gas flow propulsion has advantages such as reducing the operating voltage. Use of an interdigitated array of ion channels compensates to some extent for the lower voltage used.

While the filter structure of the present invention has been described primarily in terms of having a wafer structure, it will be apparent that suitable filter structures may be made from multiple stacked planar layers, to provide a filter having much longer ion channels than those of a wafer structure. Alternate layers of the stack may be electrically connected in parallel. While a wafer structure is particularly suited to microscale manufacture, a stacked planar arrangement may be achieved using macro scale components, such as metal coated ceramic layers, as well as microscale such as using the EFAB process. Due to the increase in length of ion channels in this embodiment, it is preferable that this embodiment of the invention operates with a combination of gas flow and electric field to drive ions through the channels.

The filter structure of the present invention may be driven differentially; that is, the AC component of the transverse field may be applied to opposing sides of the ion channel out of phase.

The ion channel may further comprise inert conductive particles located on the walls thereof; these may be nanoparticles, for example gold nanoparticles. Where the ion channel comprises silicon, over time some oxidation of the surface will occur, altering the electrical properties of the device. The inert particles will not be subject to oxidation, and so will provide a conductive surface for ion contact despite oxidation of the surface of the channel.

1-32. (canceled)

33. A device for selectively transferring ionized species from a first space to a second space, the device comprising:
a) first and second spaces separated by an ion filter allowing selective communication between the spaces;
b) at least one ion channel extending between the first and second spaces, the channel defined by a plurality of conductive layers separated along the length of the channel by at least one non-conductive layer; and
c) control means for applying an electric potential to the conductive layers such that the conductive layers act as electrodes.

34. The device of claim 33, wherein the first and second spaces are separated by a barrier, and the ion filter is disposed within the barrier.

35. The device of claim 33, wherein the control means allows electric potential to be applied to the conductive layers such that a first drive field is generated along the length of the ion channel, and a second transverse field is generated orthogonal to the first field.

36. The device of claim 35, wherein each of said plurality of conductive layers is involved in generating a component of both the drive and transverse electric fields.

37. The device of claim 35, wherein the drive and transverse electric fields are applied simultaneously.

38. The device of claim 33, wherein the control means allows the application of a time-varying electric potential to the conductive layers.

39. The device of claim 33 wherein the control means allows the electric potential to be selectively varied.

40. The device of claim 35, wherein the drive electric field is a static electric field.

41. The device of claim 35, wherein the transverse electric field comprises an AC component and a DC component.

42. The device of claim 33, wherein the conductive layers are disposed adjacent the entrance and exit to the ion channel.

43. The device of claim 33, wherein the conductive layers form at least two electrode pairs.

44. The device of claim 33, wherein the filter comprises a plurality of ion channels.

45. The device of claim 33, wherein the ion channels are defined by a plurality of electrode fingers forming a comb-like arrangement.

46. The device of claim 45, wherein the filter comprises two or more interdigitated electrode arrays, each array having a plurality of electrode fingers.

47. The device of claim 45, wherein the interdigitated fingers are curved.

48. The device of claim 33, wherein the ion channel is curved or serpentine.

49. The device of claim 33, wherein the conductive layers alternate with non-conductive layers.

50. The device of claim 33, wherein the filter has the structure C-NC-C-NC- (and optionally, a substrate), where C and NC represent conductive and non-conductive layers respectively.

51. The device of claim 33, wherein the filter has the structure C-NC- substrate-NC-C where C and NC represent conductive and non-conductive layers respectively.

52. The device of claim 33, further comprising means for heating the filter.

53. The device of claim 33, further comprising a deflector for deflecting ions towards the filter.

54. The device of claim 33, further comprising means for generating a gas flow through the filter.

55. The device of claim 33, wherein at least one of the first and second spaces carry a gas flow therethrough.

56. The device of claim 33, further comprising a membrane.

57. The device of claim 33, wherein the filter includes multiple stacked planar layers.

58. The device of claim 33, wherein the ion channel includes inert conductive particles located on the walls thereof.

59. A device for selectively transferring ionized species from a first space to a second space, the device comprising:
a) first and second spaces defined by the device that are separated by a non-permeable barrier;
b) an ion filter disposed within the barrier and allowing selective communication between the spaces; the ion filter including at least one ion channel along which ions may pass from the first to the second space, and wherein the ion filter further includes a plurality of electrodes disposed proximate the ion channel; and
c) electrode control means for controlling the electrodes such that a first drive electric field is generated along the length of the ion channel, and a second transverse electric field is generated orthogonal to the first, and wherein each of said plurality of electrodes is involved in generating a component of both the drive and transverse electric fields.

60. A method for selectively transferring ions from a first space to a second space, comprising:
a) locating ions adjacent an ion channel, the ion channel being defined by a plurality of conductive layers separated along the length of the channel by at least one non-conductive layer;
b) biasing the ions such that, in the absence of other forces, they would tend to travel along the ion channel; and
c) applying electric potential to the conductive layers, such that an electric field is established within the ion channel to selectively permit or prevent passage of the ions.

61. A device comprising:
a) a first volume defined by the device, the first volume being occupied by a first carrier fluid, the first carrier fluid including ions;
b) a second volume defined by the device, the second volume being occupied by a second carrier fluid;
c) an ion gate disposed between the first and second volumes, the ion gate including at least one channel allowing ions in the first volume to enter the second volume;
d) a first electrode adapted and configured to be at a first electric potential disposed on an inlet surface of the ion gate;
e) a second electrode adapted and configured to be at a second electric potential disposed on an outlet surface of the ion gate, the first and second electric potential providing an electric driving force to transport ions in the first volume to the second volume through the at least one channel.

62. A device comprising: a first volume occupied by a first carrier fluid, the first carrier fluid including ions; a second volume occupied by a second carrier fluid; an ion gate disposed between the first and second volumes, the ion gate including at least one channel allowing ions in the first volume to enter the second volume, a first electrode capable of being held at a first electric potential disposed on an inlet surface of the ion gate, a second electrode capable of being held at a second electric potential disposed on an outlet surface of the ion gate, in use the first and second electric potential providing an electric driving force to transport ions in the first volume to the second volume through the at least one channel.

63. A method of transporting ions in a first carrier fluid to a second carrier fluid, the method comprising:
a) providing a channel having a first electrode at a first electric potential disposed on an inlet surface facing the first carrier fluid and a second electrode at a second electric potential disposed on an outlet surface facing the second carrier fluid; and
b0 transporting ions in the first carrier fluid through the channel to the second carrier fluid by way of an electric field generated by the first and second electric potentials.

64. The method of claim 63, wherein the channel is sized to reduce transport of the first carrier fluid through the channel to the second carrier fluid.
